(19) United States
(12) Patent Application Publication
(10) Pub. No.: US 2026/0318828 A1
(43) Pub. Date: Oct. 15, 2026

(54) Method for Determining the Quantity and/or the Composition of a Pulverulent Resin Layer Applied onto a Support Material

(71) Applicant: Flooring Technologies Ltd., Kalkara (MT)

(72) Inventors: Norbert Kalwa, Horn-Bad Meinberg (DE); Jinming Zhang, Berlin (DE)

(21) Appl. No.: 18/880,893

(22) PCT Filed: Jun. 22, 2023
(86) PCT No.: PCT/EP2023/066997

§ 371 Date: Jan. 3, 2025

(30) Foreign Application Priority Data
Jul. 4, 2022 (EP) 22182895.7

(51) Int. Cl. G01N 21/359; C09D 5/03; C09D 15/00; C09D 175/02; C09D 179/02; D21G 9/00; D21H 19/24; G01N 21/3563

(52) U.S. Cl. CPC G01N 21/359; C09D 5/03; C09D 15/00; C09D 175/02; C09D 179/02; D21G 9/0009; D21H 19/24; G01N 21/3563; G01N 2021/3572

(57) ABSTRACT

A method for determining the quantity and/or the composition of at least one layer of at least one powdered resin of the resin mixture applied to at least one carrier material.

### CROSS-REFERENCE TO A RELATED APPLICATIONS

This application is the United States national phase of International Patent Application No. PCT/EP 2023/066997 filed on Jun. 22, 2023, and claims priority to European Patent Application No. 22182895.7, filed on Jul. 4, 2022, the disclosures of each of which are hereby incorporated by reference in their entireties.

### BACKGROUND

### Technical Field

The present disclosure relates to methods for determining the amount and/or the composition of at least one layer of at least one powdered resin applied to at least one carrier material.

### Technical Considerations

The use of wood-based panels in the furniture industry, as floor coverings or for cladding walls and ceilings requires the surface of the wood-based panels to be treated or finished. The wood-based panels are usually coated with an impregnated decorative paper for the applications mentioned. There are no limits to the variety of different patterned decorative papers, so that wood-based panels are available with a wide range of different decors, such as stone or wood decors. Overlays are applied to the decor paper to increase wear resistance. Thin papers are used as overlays, which are typically already impregnated with a melamine resin. Overlays are also available in which abrasion-resistant particles, such as corundum particles, are already mixed into the resin of the overlay in order to increase the abrasion resistance of the laminate or wood-based panel.

Direct printing on wood-based panels has developed in the past as an alternative to the use of decorative papers on wood-based panels, as there is no need to print paper and subsequently laminate or coat it directly onto the wood-based panel. Several liquid thermosetting resin layers are then applied to the decor applied by direct printing, which may contain abrasion-resistant particles to increase wear resistance. Such a thermosetting resin layer is also known as a liquid overlay.

The resins or glues used in these applications are usually used as liquid, often aqueous formulations for impregnating paper layers or coating carrier boards. These are applied to papers via an impregnation process in an impregnation channel or by roller application to plate-shaped carrier materials. The solvent is then evaporated by heated air or radiation. This is a relatively energy-intensive process and also leads to emissions that have to be eliminated by thermal post-combustion or an exhaust air purification system. This process is also critical from an ecological point of view.

The application quantities on papers or carrier materials are adjusted using a roller gap, squeegee etc. and then usually checked by weighing. The technology described was also used for the application of resin mixtures.

An alternative to liquid resins or glues is the use of powder resins. These can be applied to papers or carrier boards using scattering devices or spray nozzles. As these applications are contactless, the applications per unit area can at best be determined by the quantity consumed per unit time. However, inhomogeneities due to turbulence or static influences are possible with powder applications. This can be particularly problematic at the edges/limits of the system. It is also often only possible to determine the application quantities on papers or carrier materials at the end of the production line after the powder has been fixed by pressing or baking. Otherwise, the powder may fall off during sampling. This is particularly critical if several orders are placed in succession, as only the total order can be determined at the end. For many products, however, the product quality depends crucially on the exact application of the individual layers. Cost disadvantages can also occur if certain functional layers are not applied in the desired manner.

The disadvantages are therefore the lack of in-line control and the need for readjustment, which can only be carried out with a time delay. Composition fluctuations of the applied resin powder or resin powder mixtures are also not recognizable.

### SUMMARY

The present disclosure is based on the technical object of developing a non-destructive method that can determine the application quantity and composition of a powdered resin or glue application. The method should be installed in-line in production lines and provide as many measurements as possible per time unit in the production direction and transverse to it. The measurements should not disrupt the production process.

This object is solved by a method with features as described herein.

### BRIEF DESCRIPTION OF THE DRAWINGS

The present disclosure is explained in more detail below with reference to the figures.

FIG. 1: shows NIR spectra of different amounts of melamine powder resin;

FIG. 2: shows NIR spectra of different amounts of urea resin; and

FIG. 3: shows NIR spectra of urea and melamine powder resins as well as mixtures of both powder resins.

### DETAILED DESCRIPTION

In some non-limiting embodiments, a non-destructive method for determining the amount and/or composition of at least one layer of at least one powdered resin or resin mixture applied to at least one carrier material is provided, the method comprising the following steps:
Applying at least one powdered resin or a powdered mixture of at least two resins in a defined mixing ratio in different quantitatively defined quantities to a carrier material as reference samples;
Recording of at least one near-infrared radiation (NIR) spectrum of each of the reference samples using at least one NIR measuring head in a wavelength range of 700 nm to 2000 nm, preferably 900 nm to 1700 nm, more preferably 1400 nm to 1600 nm, or 1450 nm to 1550 nm;
Correlating the different quantitative amounts of powdered resin or resin mixture of the reference samples to the recorded NIR spectra of said reference samples; and
Creating a calibration model for the relationship between the spectral data of the NIR spectra and the corresponding quantitative quantities of powdered resin or resin mixture of the reference samples by means of multivariate data analysis;
Applying at least one layer of at least one powdered resin or the resin mixture to a carrier material,
Recording at least one NIR spectrum of the carrier material coated with the powdered resin or resin mixture using the at least one NIR measuring head in a wavelength range of 700 nm to 2000 nm, preferably 900 nm to 1700 nm, more preferably 1400 nm to 1600 nm, or 1450 nm to 1550 nm; and
Determining the quantitative amount of powdered resin or resin mixture applied to the carrier material by comparing the NIR spectrum recorded for the coated carrier material with the calibration model created.

According to the present method, an NIR spectrum of the amount of powdered resin or resin mixture applied to a carrier material, such as a carrier board or paper, is recorded. This makes it possible not only to determine the quantity applied but also to analyze the composition of a powdered resin or resin mixture. For this purpose, NIR spectra of different application quantities of powdered resins or resin mixtures on different carrier materials were first recorded. This was to test the influence of the carrier material on the spectrum. Surprisingly, it turned out that even application quantities of up to 600 g resin powder/m 2 can be determined. The same was then carried out with resin mixtures. Calibration models were then created which can be used to draw conclusions about unknown quantities and compositions. A further advantage is that other parameters (e.g.: moisture, see for example EP 2 915 658 B1, EP 2 808636 B1) can also be analyzed from the NIR spectra. This can also help to avoid quality defects.

It is known from US 2007/131862A1 that NIR spectroscopy can be used to determine the composition of samples from mixtures of wood particles and other components such as resin, wax, polyols and inorganic hardeners, but the samples to be measured are crushed, ground and mixed before the measurement. The aim is to monitor and improve process variables for the production of wood-based composites, such as mixing efficiency, rotation speed, resin temperature, etc.

In contrast, the method according to the present disclosure is used after provision of the finished carrier material, for example after provision of a pressed wood-based panel (e.g., HDF board) in the process of surface finishing of the wood-based panel. According to the method according to the present disclosure, the quantity and composition of a resin powder spread on a carrier material (such as a ready-pressed wood-based panel) is determined; i.e., it is not necessary to grind the sample to be measured before measuring by means of NIR spectroscopy. This allows a continuous measurement.

As explained below, the determination via NIR spectroscopy can be used for a variety of different resins/glues. These can include powdered melamine-formaldehyde resins, urea-formaldehyde resins, phenol-formaldehyde resins or mixtures thereof. Other resins can be based on powdered polyester resin, epoxy resin, etc. The powder resins may also contain additives such as hardeners, pigments, antistatic agents, etc. The use of agents to improve the application properties may also have been used.

This method can be used on a production line both in the direction of production and across it. Changes in the order quantities or in the distribution can be shown promptly through visualization.

The present method makes it possible to provide the measured values in a short time (online, preferably without disruptive time delay) compared to conventional (known) measurement methods. The measurement data can be used for quality assurance, research and development, process control, process regulation, process control, etc. The measurement process does not reduce the production speed, etc. Basically, it improves the monitoring of production. In addition, downtimes are also reduced through quality determinations and system adjustments.

The determination of the application quantity of powdered resin or resin mixture that is possible with the present method is preferably carried out exclusively by means of NIR measurement. A combination with other spectroscopic methods, using other wavelengths outside the NIR range, is not intended.

An NIR measuring head is therefore used, preferably an NIR multi-measuring head, which allows the amount of powdered resin to be determined by recording spectral data (spectra) in the near-infrared range (700-2000 nm). The NIR radiation interacts with the organic functional groups, such as O—H, C—H and N—H, which are present in both urea and melamine resins, for example. During the interaction, the NIR radiation is scattered and reflected by the measured sample. By receiving the reflected NIR radiation via an NIR detector, an NIR spectrum is generated. During this measurement, a large number of individual NIR measurements are carried out in one second, so that statistical validation of the values is also guaranteed. NIR spectroscopy together with multivariate data analysis (see below) offers a way of establishing a direct link between the spectral information (NIR spectra) and the parameters of the applied resin layer to be determined.

The present method utilizes the fact that the NIR radiation does not penetrate through the carrier material, but is reflected or scattered on the surface of the carrier material. The reflected or scattered NIR radiation is detected by the NIR detector, and the NIR spectrum determined is used to determine the desired parameters (in this case the amount of powdered resin applied).

Spectral data from the entire recorded spectral range is preferably used to determine the amount of powdered resin applied, i.e. a whole range of several wavelengths is used rather than a single, discrete wavelength.

According to the method according to the present disclosure, reference samples of the carrier material coated with a resin or resin mixture are therefore first provided. To provide the reference samples, various quantities of powdered resin or a powdered resin mixture, e.g., 10 g/m², 20 g/m², 40 g/m², 60 g/m², 80 g/m²and/or 100 g/m² are applied to the respective carrier material to be coated.

In the case of a powdered resin mixture, a defined mixture of a first powdered resin and a second powdered resin, e.g., a defined mixture of urea resin and melamine resin, is applied to the carrier material to be coated. Mixtures with a ratio of first powdered resin and second powdered resin in a ratio of 25 wt %: 75 wt %, 50:50 wt %, 75 wt %: 25 wt % are applied as reference samples. In this series, 100% of the first powdered resin and 100% of the second powdered resin were determined as reference samples.

It should also be noted that the reference sample is identical to the sample to be measured; i.e., the resin layer of the reference sample has the same composition as the resin layer to be measured. The homogeneity of the sample to be measured and the reference sample may be important when using powdered resin layers with additives such as flame retardants, fibers and/or other additives.

At least one NIR spectrum of these reference samples is recorded in a wavelength range of 700 nm to 2000 nm, preferably 900 nm to 1700 nm, more preferably 1400 nm to 1600 nm, or 1450 nm to 1550 nm.

The different quantitative quantities of powdered resin of the reference samples are then assigned to the respective NIR spectra of these reference samples recorded and a calibration model is created for the relationship between the spectral data of the NIR spectra of the reference samples and the associated resin quantities as a parameter value by means of a multivariate data analysis; i.e., an NIR spectrum of the reference sample corresponds to each parameter value of the reference sample. The calibration models created for the various parameters are stored in a suitable data memory.

Subsequently, at least one layer of at least one powdered resin or resin mixture is applied to a carrier material, and at least one NIR spectrum of the powdered resin layer applied to the carrier material is recorded. The quantitative amount of the powdered resin or resin mixture applied to the carrier material can be determined by comparing the NIR spectrum recorded for the coated carrier material with the calibration model created.

It makes sense to compare and interpret the NIR spectra over the entire recorded spectral range. This is advantageously carried out using a well-known multivariate data analysis (MDA). In multivariate analysis methods, several statistical variables are typically analyzed simultaneously in a known manner. For this purpose, these methods usually reduce the number of variables contained in a data set without simultaneously reducing the information contained therein.

In this case, the multivariate data analysis is carried out using the partial least squares regression (PLS) method, which allows a suitable calibration model to be created. The evaluation of the data obtained is preferably carried out using suitable analysis software, such as the SIMCA-P analysis software from Umetrics AB or The Unscrambler from CAMO.

In a some non-limiting embodiments, it is provided to use spectral data from the NIR spectral range of 1450 to 1550 nm for the creation of the calibration model, which are pre-treated using suitable mathematical methods and then fed to the multivariate data analysis.

The significance of a wavelength for the prediction of parameters of the resin layer, such as the amount of resin, from the NIR spectrum is shown with the help of the regression coefficients. The regions with large coefficients have a strong influence on the regression model. For example, the representation of the regression coefficients in a PLS regression model for determining the resin quantity or resin content shows that the wavelength range of 1460 nm to 1530 with a maximum at 1490 nm (absorption band of the amino groups of the resin) is the most important for calculating the model, as the amounts of the regression coefficients are the largest here. Although the other areas in the spectrum have less information content in relation to the NIR measurement, they nevertheless help to take into account or minimize the other information or interfering influencing variables (such as transparency of the coating, surface properties of the resin coating or the carrier material, etc.).

To eliminate interfering influences (such as the nature of the carrier material surface, sample color, light scattering from solid particles and/or other additives, etc.), it is necessary to process the spectral data using mathematical pretreatment methods (e.g., derivative data pretreatment, standardization according to SNVT (Standard Normal Variate Transformation), multiplicative signal correction (EMSC, Extended Multiplicative Signal Correction, etc.). The baseline effects, which are mainly caused by the different colors of the samples, are removed from the spectra, overlapping bands are separated and the dependence of the light scattering on the carrier material surface or on the solid particles in the coating is taken into account. If, for example, the resin application rate is to be determined on untreated surfaces of carrier materials such as wood-based panels, the data pre-treatment is preferably carried out to reduce the light scattering on the rough surface of the carrier material. When measuring on decorative coatings, the focus of calibration and data pre-treatment is on removing the baseline shift.

In some non-limiting embodiments of the present disclosure, the powdered resin to be applied is a formaldehyde resin, preferably a urea resin, a melamine resin or a phenolic resin, more preferably a melamine-formaldehyde resin or a urea-formaldehyde resin. Other resins based on powdered polyester resin, epoxy resin, etc. can also be used.

The particle size of the powdered resin is 20 to 100 μm, preferably 40 to 89 μm.

In some non-limiting embodiments of the present disclosure, at least one mixture of at least two powdered resins is applied to the at least one carrier material. A mixture of urea and melamine resin is preferred. Urea and melamine resins have very similar NIR spectra, with the urea resin peak being in the shoulder of the melamine resin peak.

The at least one mixture may comprise a first powdered resin and a second powdered resin in a ratio of 10 wt %: 90 wt % to 90 wt %: 10 wt %, preferably 25 wt %: 75 wt % to 75 wt %: 25 wt %, more preferably 55 wt %: 45 wt % to 45 wt %: 55 wt %, e.g., 50:50 wt %.

In some non-limiting embodiments of the present disclosure, the powdered resin or the mixture of at least two powdered resins is applied to the at least one carrier material in an amount of up to 600 g/m 2, preferably up to 400 g/m², or more preferably up to 200 g/m². Thus, the powdered resin or the mixture of at least two powdered resins can be applied to the at least one carrier material in an amount of 10 to 150 g/m², preferably 20 to 100 g/m², more preferably 40 to 80 g/m².

Other substances can also be added to the resin powder. In some non-limiting examples, it is advantageous that substances that are poorly compatible with liquid melamine resin, e.g., due to salting-out, thickening, settling, and/or curing-influencing effects, etc., can also be used. These may be salts to increase conductivity, organic and/or inorganic flame retardants, cellulose derivatives, radical scavengers, pigments, and/or UV absorbers, etc.

Accordingly, in some non-limiting embodiments, the powdered resin used may comprise additives such as pigments, conductive substances and/or cellulose.

If color pigments are added, the layer of resin powder can also serve as a white base coat layer for a decorative layer that may subsequently be printed on. White pigments such as titanium dioxide TiO₂ can be used as color pigments. Other color pigments can be calcium carbonate, barium sulfate or barium carbonate. The proportion of color pigments can be up to 50% by weight of the total powder quantity.

The addition of color pigments to the first layer of resin powder increases the opacity so that it can be used as the (sole) base or base coat for the subsequent decorative layer.

The amount of cellulose fibers applied with the resin powder can be 0.1 to 1 wt %, preferably 0.5 to 0.8 wt % (based on the amount of resin applied) or 0.1-0.5 g/m², preferably 0.2-0.4 g/m 2, or more preferably 0.25g/m². The cellulose fibers preferably used are colorless and are in the form of a fine or granular, slightly hygroscopic powder.

The conductive substances can be selected from the group comprising carbon black, carbon fibers, metal powder and/or nanoparticles, for example carbon nanotubes. Combinations of these substances can also be used.

The resins used preferably comprise additives such as hardeners, wetting agents (surfactants or mixtures thereof), release agents and/or other components.

In some non-limiting embodiments, a paper layer is used as the carrier material. For example, overlay papers, decor papers or kraft papers are used as the paper layer. Overlay papers are thin papers that have typically already been impregnated with a conventional melamine resin. Overlay papers are also available in which abrasion-resistant particles, such as corundum particles, are already mixed into the resin of the overlay in order to increase abrasion resistance. Decor papers are specialty papers for surface finishing of wood-based materials that allow for a wide variety of decors. In addition to the typical imprints of various wood structures, further imprints of geometric shapes or artistic products are available. There is virtually no restriction in the choice of motif. Kraft papers are very strong and consist of cellulose fibers to which starch, alum and glue are added in order to achieve surface effects and increased strength.

In some non-limiting embodiments, a carrier board is used as the carrier material. In this case, this carrier board is preferably a board made of a wood-based material, plastic, a wood-based material/plastic mixture or a composite material, for example a chipboard, medium-density fiberboard (MDF), high-density fiberboard (HDF), oriented strand board (OSB) or plywood board, a cement fiberboard, gypsum fiberboard or a WPC board (Wood Plastic Composites) or an SPC board (Stone Plastic Composite).

As already indicated above, the method according to the present disclosure for determining the amount of powdered resin or resin mixture applied to the carrier material can be carried out continuously and online in a production line, for example in a production line for manufacturing wood-based panels or in a production line for impregnating paper layers. In some non-limiting embodiments, the process can be carried out in an automatically controlled system with alarm signaling.

The amount of powdered resin applied to at least one carrier material can be determined several times in the production line, for example in each case after leaving a device for applying a layer of powdered resin.

In some non-limiting embodiments of the measuring method according to the present disclosure, it is provided that the at least one NIR measuring head moves transversely to the running direction of the carrier material provided with the powdered resin in the production line and traverses over the entire width of the carrier material in order to analyze certain problem areas, for example shortfall orders in the edge or middle area of the carrier material.

In some non-limiting embodiments of the measuring method according to the present disclosure, it is provided that the at least one NIR measuring head moves in the direction of travel of the carrier material provided with the powdered resin in the production line; i.e., in this embodiment, the measuring head can remain stationary in a position which may be considered to be important, for example.

A method is thus provided in which, by using an NIR measuring head, the quantity and composition of an applied resin powder or resin mixture can be determined from a single NIR spectrum or the reflection or scattering of NIR radiation, by means of a non-contact measurement. In some advantageous and non-limiting embodiments of the present disclosure, the data determined with the measuring head or measuring heads are used directly for system control or regulation.

In addition, in a further advantageous and non-limiting embodiment of the present disclosure, the storage of the data makes it possible to improve quality control. The stored data can also make an advantageous contribution to the evaluation of system tests, e.g., commissioning of a system during new installation or after maintenance or repair or for in-situ testing of new production or measurement processes. The immediate availability of the measured values and the high measurement frequency enable very close monitoring, control and/or regulation of the systems.

The advantages of this method are manifold: non-contact multi-parameter determination (“real time” or “real-time” measurement) with significantly reduced time delay in the evaluation of the measured parameter values; improved system control and/or regulation, reduction of rejects, improvement of the quality of the products manufactured on the system, and/or improvement of system availability.

The control system of the respective production plant comprises at least one computer-aided evaluation unit (or processor unit) and a database. In the evaluation unit, the NIR spectrum measured for the product (i.e., coated carrier material) is compared with the calibration models created for the individual parameters. The parameter data determined in this way is stored in the database.

The data determined using this spectroscopic method can be used to control the respective production line. The non-contact measured parameter values of the NIR multi-measurement head (“actual values”) can, as described above, be used directly and in “real time” for the control or regulation of the relevant system, for example by storing the actual values measured and stored in the database, e.g., a relational database, and comparing them with the target values of these parameters available there. The resulting differences are then used to control or regulate the production line.

A computer-implemented method and a computer program product comprising instructions which, when the program is executed by at least one processor, cause the processor to execute the computer-implemented method, are provided for the adjustment and control of the respective production line. The computer program is stored in a memory unit of the control system of the respective production line. In some non-limiting embodiments, the at least one processor may be implemented in hardware, firmware, or a combination of hardware and software.

Two processes and production lines in which the measuring method according to the present disclosure can be used are described in detail below.

Thus, a first process for manufacturing a wood-based panel provided with a decor comprises the following steps:
a) Applying at least a first layer of at least one powdered resin or resin mixture to at least one side of a wood-based panel and melting-on the at least one applied layer of powdered resin;
b) Applying at least one decorative layer by means of a direct printing process; and
c) Applying at least one further (second) layer of at least one powdered resin or resin mixture to the at least one printed decorative layer and melting-on the at least one layer of powdered resin spread on the decorative layer.

The measuring method according to the present disclosure for determining the application quantity of the powdered resin (or powdered resin mixture) is preferably carried out following the respective step of applying the first and/or second and/or each further layer of powdered resin.

“Melting-on ” or “gelling” in the sense of the present application means that the resin layer is not yet fully polymerized, but rather that the polymerization is stopped at an intermediate stage in which further crosslinking or polymerization is still possible at a later processing time. The purpose of “gelling” is therefore usually to apply further functional layers to the already applied protective layer at a later stage or to finish the product in further processing steps.

In some non-limiting embodiments, the resin powder is applied by means of electrostatic charging. It can also be applied by powder coating using the tribo process. In this case, the powder to be applied is frictionally charged.

The melting-on of the applied layer of powdered resin or resin mixture can be carried out using an IR emitter, or microwave systems or similar. The use of IR emitters is preferred.

The surface of the carrier board can be surface-treated, e.g., in the case of a wood-based carrier board, the surface can be sanded or not sanded and provided with a pressed skin. In the case of a plastic core board, the surface can be corona-treated.

In some non-limiting embodiments, at least one base coat is applied to the (first) fused-on resin powder layer in a next step to increase the opacity.

The base coat preferably comprises casein, corn starch and/or soy protein and may contain inorganic color pigments and thus serve as a base coat layer for the decorative layer to be subsequently printed on.

White pigments such as titanium dioxide TiO2 can also be used as color pigments. Other color pigments can be calcium carbonate, barium sulfate and/or barium carbonate, but also iron oxide pigments (for a brownish base coat). In addition to the color pigments and casein, corn starch and or soy protein, the base coat can also contain water as a solvent.

The amount of liquid base coat applied can be 10 to 50 g/m², preferably 15 to 30 g/m², preferably 20 to 25 g/m².

It is also conceivable that the base coat comprises or consists of at least one, preferably at least two or more successively applied layers or coats (e.g., up to five coats), whereby the application quantity between the layers or coats is the same or different, i.e., the application quantity of each individual layer can vary.

The base coat can be applied to the wood-based carrier board using a roller with subsequent drying. It is also possible to apply the base coat to the plastic carrier board using digital printing. The digital printing inks used for digital printing of the base coat are preferably based on UV inks or water-based inks that are enriched with white color pigments. However, it is also possible to use water-based digital printing inks or so-called hybrid inks. Application using digital printing is advantageous as the printing system is significantly shorter than a roller device and therefore saves space, energy and costs.

In some non-limiting embodiments of the present disclosure, a primer layer is applied to the base coat, preferably as a single application with subsequent drying. The primer layer can be useful in the case of a subsequent gravure printing process (with rollers), whereas this is not absolutely necessary when using a digital printing process.

The amount of liquid primer applied is 10 to 30 g/m², preferably 15 to 20 g/m². Polyurethane-based compounds are preferred as primers.

Gravure and digital printing processes are advantageously used as direct printing methods for printing the wood-based panel. The gravure printing process is a printing technique in which the elements to be depicted are present as indentations in a printing form that is inked before printing. The ink is primarily located in the indentations and is transferred to the object to be printed, such as a carrier material, due to the contact pressure of the printing form and adhesion forces. When using indirect gravure printing, several printing rollers are used.

In some non-limiting embodiments, the at least one decor is applied to the (surface-treated and pre-coated) carrier board using a digital printing process. In digital printing, the printed image is transferred directly from a computer having at least one processor to a printing machine, such as a laser printer or inkjet printer. This eliminates the use of a static printing form. Decorative printing is carried out using the inkjet principle in single-pass printing, in which the entire width of the top side to be printed is covered and the boards are moved under the printer. However, it is also possible for the carrier board to be printed on to be stopped under the printer, which then passes over the surface at least once during printing.

The print colors are combined in separate print head rows, whereby one or two rows of print heads can be provided for each color. The colors of the digital printing inks are for example black, blue, red, reddish yellow, greenish yellow, optionally CMYK can also be used. The digital printing inks are optionally based on the same pigments that are used for analog and/or digital printing with water-based inks. The digital printing inks are preferably based on UV inks. However, it is also possible to use water-based digital printing inks or so-called hybrid inks. After printing, the decor print is dried and/or irradiated.

The printing inks are applied in a quantity of 1 to 30 g/m², preferably 3 to 20 g/m², more preferably 3 to 15 g/m².

The markings required for alignment in the press are also printed together with the decor.

After this process step, the printed panel can be sent for intermediate storage. In this case, the applied and melted-on resin powder layer serves as a protective layer, which on the one hand serves to protect the printed surface in the event of intermediate storage and on the other hand (due to the not yet fully cured resin layer) enables further processing. In complex manufacturing processes, it is necessary to decouple certain work steps for reasons of cost, technology, etc. For example, the productivity of interlinked production lines can vary greatly. In this case, it is inevitable that buffer storage facilities must be set up in which materials are stacked on top of each other. Furthermore, multiple runs may be necessary in a production line because order quantities, etc., cannot be realized in a single run. In all of these cases, dried or hardened surfaces are advantageous, as they protect the printed surface in the event of temporary storage and also enable further processing.

In some non-limiting embodiments, abrasion-resistant particles are evenly sprinkled onto the decorative layer or the resin powder layer applied in step c) (step d).

Particles of corundum (aluminum oxides), boron carbides, silicon dioxides and/or silicon carbides can be used as abrasion-resistant particles. Corundum particles are preferred. Preferably, these are high-grade corundum (white) with a high transparency so that the visual effect of the underlying decoration is affected as little as possible. Corundum has a non-uniform spatial shape.

The quantity of scattered abrasion-resistant particles is 7 to 50 g/m², preferably 10 to 30 g/m², more preferably 15 to 25 g/m². The quantity of scattered abrasion-resistant particles depends on the abrasion class to be achieved and the particle size. In the case of abrasion class AC3, for example, the quantity of abrasion-resistant particles is 10 to 15 g/m², in abrasion class AC4 is 15 to 20 g/m² and in abrasion class AC5 is 20 to 35 g/m² when using grain size F200. In this case, the finished panels preferably have abrasion class AC4.

Abrasion-resistant particles with grain sizes in classes F180 to F240, preferably F200, are used. The grain size of class F180 covers a range of 53-90 μm, F220 45-75 μm, F230 34-82 μm, F240 28-70 μm (FEPA standard). In one variant, the abrasion-resistant particles used are white fused alumina F180 to F240, preferably in a main grain size range of 53-90 μm. In some non-limiting embodiments, corundum particles of classes F180-220 are used. The abrasion-resistant particles must not be too fine-grained (risk of dust formation), but also not too coarse-grained. The size of the abrasion-resistant particles is therefore a compromise. In some non-limiting embodiments, silanized corundum particles can be used. Typical silanizing agents are aminosilanes.

In some non-limiting embodiments of the present disclosure, at least a third layer of at least one powdered resin (step e) is applied and melted-on, for example to the layer of abrasion-resistant particles. This layer serves as a separating layer for blocking the abrasion-resistant particles.

In some non-limiting embodiments of the present disclosure, glass beads are sprinkled on, for example on the at least one third fused-on resin powder layer (step f). The glass beads act as spacers between abrasion-resistant particles and the subsequent pressed sheet. This allows the sheet wear to be at least partially reduced.

In some non-limiting embodiments, the glass beads have a diameter of 60-120 μm, preferably 80-90 μm. The diameter of the glass beads is matched to the average particle size of the abrasion-resistant particles used in order to ensure an optimum barrier to the subsequent pressed sheet. In the case of corundum F220, glass beads with a diameter between 70-90 μm are used, and in the case of corundum F180, glass beads with a diameter between 80-120 μm are used. The quantity of glass beads is 5 to 30 g/m², preferably 8 to 20 g/m², more preferably 8 to 15 g/m². The glass beads can also be in silanized form. Silanization of the glass beads improves the embedding of the glass beads in the resin matrix.

In some non-limiting embodiments of the present disclosure, at least a fourth layer of at least one powdered resin (step f) is applied and melted-on, for example to the layer of glass beads. This layer serves to seal off the glass beads and as a final layer.

In some non-limiting embodiments of the present disclosure, the layered structure is pressed in a short-cycle press (KT press) (step h). The pressing step is carried out under the influence of pressure and temperature at temperatures of 180 to 250 °C, preferably 200 to 230 °C, more preferably at 200 °C, and a pressure of 30 to 60 kg/cm², preferably 40 to 50 kg/cm². The pressing time is 8 to 30 seconds, preferably 10 to 25 seconds.

Preferably, the coated wood-based panel is aligned in the short-cycle press with a textured press plate located in the short-cycle press using markings on the wood-based panel so that the decor on the wood-based panel and the texture of the press plate to be embossed are aligned. This enables the production of a decor-synchronized structure. During pressing, the melamine resin layers melt and a laminate is formed by a condensation reaction involving the corundum/glass/fiber components.

A backing, e.g., comprising or consisting of several layers of resin without additives or a backing paper, can be applied to the underside of the wood-based panel. This ensures that the tensile forces on the wood-based panel caused by the applied layers during pressing cancel each other out. The layer structure and the respective layer thickness of the backing applied to the underside corresponds approximately to the layer sequence applied to the top side, but without the addition of abrasion-resistant particles or glass beads. An impregnate can also be used as a backing.

The production line for manufacturing a carrier board with a decor, for example a wood-based panel, can therefore comprise the following elements:
at least one application device for applying a first resin powder layer, which may comprise fibers, to the upper surface of the wood-based board and at least one device for melting-on the first resin powder layer, for example an IR emitter;
optionally at least one application device for applying at least one base coat layer;
optionally at least one application device for applying at least one primer layer;
at least one printing device,
optionally at least one application device for applying a further resin powder layer and at least one device for melting-on the resin powder layer, in particular an IR emitter;,
optionally at least one device for scattering a predetermined quantity of abrasion-resistant particles;
at least one application device for applying a further resin powder layer and at least one device for melting-on the resin powder layer, for example an IR emitter;
optionally at least one device for scattering a predetermined quantity of glass beads;
optionally at least one application device for applying a further resin powder layer and at least one device for melting-on the first resin powder layer, in particular an IR emitter; and
optionally at least one short-cycle press arranged downstream of the last drying device in the processing direction;
wherein at least one NIR measuring head, preferably at least one NIR multi-measuring head, is provided after the application device for applying a first resin powder layer and/or after the application devices for applying in each case a further resin powder layer, for recording at least one NIR spectrum of the wood-based panel coated with the powdered resin.

As mentioned, the NIR measuring method according to the present disclosure can also be used for coating paper layers with resin powder.

A method for coating a paper layer as a carrier material comprises the following steps:
applying at least one layer of at least one powdered resin (or powdered resin mixture) to at least one side of a paper layer and melting-on the at least one applied layer of powdered resin or resin mixture; and
Drying and hardening of the layer structure.

The measuring method according to the present disclosure for determining the application quantity of the powdered resin (or powdered resin mixture) is preferably carried out following the step of applying the layer of powdered resin or resin mixture.

A production line used for coating paper layers with a powdered resin comprises at least one application device for applying at least one resin powder layer, for example by means of tribo-guns, at least one device for melting-on the resin powder layer, preferably using an IR emitter, and at least one device for drying and curing the coated paper layer.

At least one NIR measuring head is provided after the application device for applying a resin powder layer for recording at least one NIR spectrum of the paper layer coated with the powdered resin.

In both non-limiting embodiments of the production lines (wood-based panel, impregnate), the NIR measuring heads are each connected to a control system with an evaluation unit and database for processing and storing the NIR data obtained. If the measured actual values deviate from the target values, an automatic adjustment is made by the system control or regulation. In principle, all NIR measuring heads used in a production line supply the actual values measured by them to the central control and evaluation unit, which regulates the production process accordingly or controls it proactively if the measured actual values of, for example, a single NIR measuring head deviate from the corresponding target values.

### Example 1

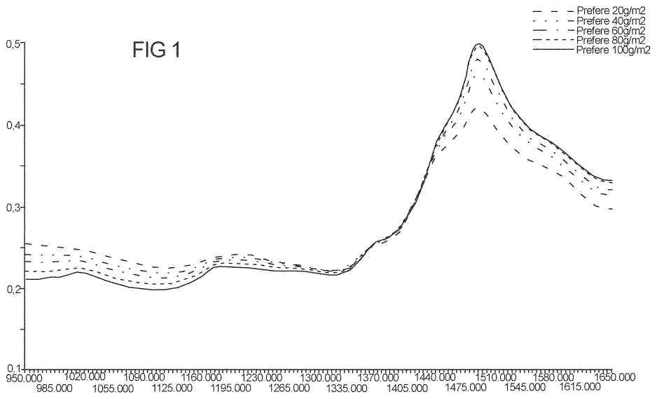

Various quantities of powdered melamine resin were applied to a decorative paper in a medium color shade (20, 40, 80 and 100 g powder resin/m²). Spectra of the different application quantities were produced with the aid of an NIR measuring head. A calibration model was created from these spectra with the aid of software. The peak at approx. 1500 nm proved to be particularly suitable (see FIG. 1). Then unknown application quantities of melamine resin were determined on different carrier materials with different background colors.

### Example 2

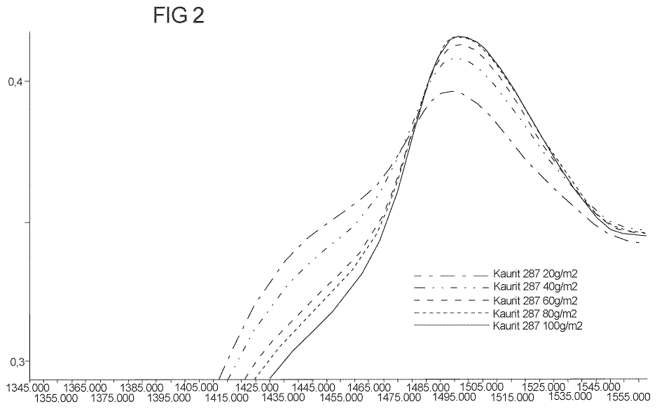

The same procedure was chosen for powdered urea resin. The same application quantities were analyzed. Here too, the peak around approx. 1500 nm were used to create a calibration model (see FIG. 2).

### Example 3

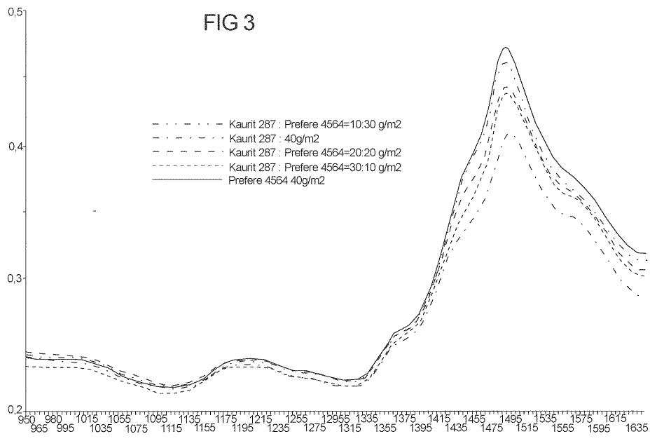

Mixtures of urea and melamine resin were then prepared. The total quantity was 40 g/m² in each case. It was varied between 100%, 25%/75%, 50%/50%, 25%/75% and 100%. Here, too, an analysis was possible. The spectra of the mixtures lay between the spectra of urea powder resin and melamine powder resin. They approached the melamine spectrum with increasing melamine content. Here too, the peak around 1500 nm was suitable for creating a calibration (see FIG. 3). Once a calibration has been created, the homogeneity of the mixture can be checked for powder mixtures or application quantities can be determined.

1. A non-destructive method for determining the quantity and/or the composition of at least one layer of at least one powdered resin or resin mixture applied to at least one carrier material
comprising the steps of
Applying at least one powdered resin or a powdered mixture of at least two resins in a defined mixing ratio in different quantitatively defined quantities to a carrier material as reference samples;
Recording at least one NIR spectrum of each of the reference samples using at least one NIR measuring head in a wavelength range of 700 nm to 2000 nm;
Correlating the different quantitative amounts of powdered resin or resin mixture of the reference samples to the recorded NIR spectra of said reference samples; and
Creating a calibration model for the relationship between the spectral data of the NIR spectra and the corresponding quantitative quantities of powdered resin or resin mixture of the reference samples by means of multivariate data analysis;
Applying at least one layer of at least one powdered resin or resin mixture to a carrier material,
Recording at least one NIR spectrum of the carrier material coated with the powdered resin or resin mixture using the at least one NIR measuring head in a wavelength range of 700 nm to 2000 nm; and
Determining the quantitative amount of powdered resin or resin mixture applied to the carrier material by comparing the NIR spectrum recorded for the coated carrier material with the calibration model created.

2. The method according to claim 1, wherein the powdered resin is a formaldehyde resin, a urea resin, a melamine resin and/or a phenolic resin.

3. The method according to claim 1, wherein at least one mixture of a first powdered resin and a second powdered resin is applied to the at least one carrier material.

4. The method according to claim 3, wherein the at least one mixture comprises a first powdered resin and a second powdered resin in a ratio of 10 wt %: 90 wt % to 90 wt %: 10 wt %;

5. The method according to claim 1, wherein the powdered resin least one of pigments, conductive substances and/or cellulose.

6. The method according to claim 1, wherein the powdered resin or the mixture of at least two powdered resins is applied in an amount of up to 600 g/m².

7. The method according to claim 1, wherein the powdered resin or the mixture of at least two powdered resins is applied in an amount of 10 to 150 g/m².

8. The method according to claim 1, wherein the at least one carrier material comprises at least one paper layer.

9. The method according to claim 1, wherein the at least one carrier material is a board made of a wood-based material, plastic, a wood-based material/plastic mixture or a composite material, a cement fibreboard, gypsum fibreboard, a WPC board (Wood Plastic Composites) or an SPC board (Stone Plastic Composites).

10. The method according to claim 1, wherein spectral data from the entire recorded spectral range are used to determine the amount of powdered resin or resin mixture applied.

11. The method according to claim 1, wherein the determination of the amount of powdered resin or resin mixture applied to the carrier material is carried out continuously and online in a production line.

12. The method according to claim 11, wherein the at least one NIR measuring head moves transversely to the running direction of the carrier material provided with the powdered resin in the production line and traverses over the entire width of the carrier material in order to analyze certain problem areas.

13. The method according to claim 11, wherein the at least one NIR measuring head moves in the production line in the direction of travel of the carrier material provided with the powdered resin.

14. The method according to claim 11, wherein the determination of the amount of powdered resin or resin mixture applied to at least one carrier material is carried out several times in the production line.

15. The method according to claim 1, using the at least one NIR measuring head in a wavelength range of 900 nm to 1700 nm.

16. The method according to claim 2, wherein the powdered resin is a urea resin, a melamine resin or a phenolic resin.

17. The method according to claim 4, wherein the at least one mixture comprises a first powdered resin and a second powdered resin in a ratio of 25 wt %: 75 wt % to 75 wt %: 25 wt %.

18. The method according to claim 6, wherein the powdered resin or the mixture of at least two powdered resins is applied in an amount of up to 400 g/m².

19. The method according to claim 7, wherein the powdered resin or the mixture of at least two powdered resins is applied in an amount of 20 to 100g/m².

20. The method according to claim 9, wherein the at least one carrier material is a chipboard, medium-density fibreboard (MDF), high-density fibreboard (HDF), oriented strand board (OSB) or plywood board, plastic, a wood-based material/plastic mixture or a composite material, a cement fibreboard, gypsum fibreboard, or a WPC board (Wood Plastic Composites) or an SPC board (Stone Plastic Composites).
